(19) United States
(12) Patent Application Publication
(10) Pub. No.: US 2026/0065230 A1
(43) Pub. Date: Mar. 5, 2026

(54) SYSTEMS AND METHODS FOR ADMINISTERING AND AUTOMATING A SPONSORED EMERGENCY SAVINGS PROGRAM

(71) Applicant: Secure, Inc., Kirkland, WA (US)

(72) Inventors: Devin Miller, North Bend, WA (US); Bassam Saliba, Kirkland, WA (US); Zachary Scott Shannon, Denver, CO (US); Elaine Gilbert Levey, Seattle, WA (US); Gopal Annasundarum, Sammamish, WA (US)

(73) Assignee: Secure, Inc., Kirkland, WA (US)

(21) Appl. No.: 19/275,707

(22) Filed: Jul. 21, 2025

Related U.S. Application Data
(60) Provisional application No. 63/673,642, filed on Jul. 19, 2024.

(51) Int. Cl. G06Q 10/1057; G06Q 40/12

(52) U.S. Cl. CPC G06Q 10/1057; G06Q 40/125

(57) ABSTRACT

An embodiment of a system includes a secure savings-administration processor configured to establish, at a financial institution, an emergency savings account for an employee of an employer, and to direct, to the emergency savings account, a payroll deduction taken by the employer from wages that the employer pays to the employee. The system also can include a database for storing information related to the financial institution, the emergency savings account, the employee, or the employer.

### CLAIM OF PRIORITY AND CROSS-REFERENCE TO RELATED APPLICATIONS

This application claims priority to U.S. Provisional Patent Application Ser. No. 63/673,642 filed Jul. 19, 2024.

This application relates to U.S. patent application Ser. No. 18/226,715 filed Jul. 26, 2023, which is a continuation of U.S. patent application Ser. No. 17/551,060 filed Dec. 14, 2021 (now U.S. Pat. No. 11,748,720 issued Sep. 5, 2023) which claims priority to U.S. Provisional Patent Application No. 63/199,212 filed Dec. 14, 2020.

This application hereby incorporates by reference the above applications in their entireties as if fully set forth herein.

### COPYRIGHT NOTICE

This disclosure is protected under United States and/or International Copyright Laws. © 2024 Secure, Inc. All Rights Reserved. A portion of the disclosure of this patent document contains material which is subject to copyright protection. The copyright owner has no objection to the facsimile reproduction by anyone of the patent document or the patent disclosure, as it appears in the Patent and/or Trademark Office patent file or records, but otherwise reserves all copyrights whatsoever.

### BACKGROUND

Having a well-funded emergency savings account typically is at the heart of financial wellness. The ability to cover a financial setback or a temporary lapse in pay without having to borrow money or to obtain a loan can reduce feelings of financial stress and can even make people happier. According to a study from Northwestern Mutual, 92% of Americans indicated that nothing makes them happier than having their finances in order.

But for too many people, having a well-stocked emergency savings account can seem like a pipedream. A survey from Varo Money found that two-thirds of their clients ‘sometimes’ or ‘constantly’ feel stressed because they do not have a three-month emergency fund. Even those with a savings account usually do not have enough to cover most emergencies. A Federal Reserve survey found that almost 40% of participants would not be able to cover an unexpected $400 expense using cash. A Bankrate poll found another 40% of Americans would need to borrow money to cover a $1,000 emergency. Even more dismal are findings from John Hancock's 2019 Financial Stress Survey, which reported that one quarter of Americans have no savings whatsoever, including 16% of baby boomers and 31% of Generations X, Y, and Z.

Not surprisingly, money is the dominant source of stress for 44% of Americans, causing “high” or “moderate” levels of anxiety, according to Northwestern Mutual. The National Endowment for Financial Education has also reported that 30% of U.S. adults are “constantly” worried about their financial situation. During 2020, in the midst of a worldwide pandemic, those levels worsened. Almost 9 in 10 Americans said COVID-19 caused stress on their personal finances.

Given the above information, one may wonder if the majority of this financial anxiety stems from lack of savings, then why aren't Americans saving more. It has been found that it is not that Americans do not know the actions that they can take to calm their concerns. The John Hancock survey found that most people knew that taking steps such as setting financial goals (33%) or learning to live on less (31%) could reduce their financial concerns. But there was a notable gap between Americans knowing the actions to take and actually taking them. The John Hancock survey found that only 21% of Americans had actually set any financial goals, and a meager 20% of Americans had taken steps to live on less money.

### SUMMARY

An answer, then, may lie in making saving money easier for people, which is what employer-sponsored emergency savings accounts (ESAs) do by allowing workers to set aside a portion of every paycheck into a rainy-day fund through automatic payroll deductions.

Such programs, including emergency savings accounts, in their current forms, have numerous flaws in their designs and in the administrative systems that support them, and these flaws can reduce the ability of employers to offer such programs, individuals to use such programs, and providers to support such programs.

These flaws generally fall into the following four core categories:

1. Lack of Ease and Automation of Employer Administration. Making an emergency savings program easy to administer and to support by an employer can be key to the long-term success of such a program. Current programs can require an excess of manual administrative time and can be overly complicated in their nature (e.g., structure, rules).

2. Lack of Ease and Automation of Employee Participation. To best support the goal of such programs, the initial introduction of, the ongoing maintenance of, and the access to an emergency savings program typically should be very easy for an individual and make the process of starting, and continuing, to save money as easy and rewarding as possible for the individual. For example, an employer can provide, to employees, one or more incentives for opening ESAs and contributing to the ESAs via the emergency savings program. Such incentives can include funds, contributed by the employer, that partially or fully match the funds contributed to an ESA by an employee. Other incentives can include, e.g., items or services such as gift cards, reduced-price or free products or activities, reduced-price or free gaming-related items such as free game “lives”, or other monetary or non-monetary rewards.

3. Lack of Support for an Individual During an Emergency. An effective emergency savings program typically should not only help individuals save money, but also typically should support the individual during an unexpected financial emergency.

4. Lack of Ease and Automation of Compliance and Platform Coordination.

National and state-level laws, along with general banking and financial rules and elements that typically must be navigated to support such a program, typically require a high level of automation (e.g., automatic payroll deductions), compliance (e.g., with applicable rules and laws), and coordination (e.g., of computer/software platforms) between third parties to be successful.

One or more embodiments described herein provide for a centralized emergency saving account system. Such a system can overcome problems in the industry because there is currently no system that is operable to interface with multiple employers or multiple financial institutions (e.g., banks and credit unions), and because of one or more other reasons. In an embodiment, a system includes a database and a secure savings-administration processor communicatively coupled to the database, the secure savings-administration processor being operable to interface with a plurality of payroll systems of a plurality of employers, to interface with a plurality of financial-institution interfaces of a plurality of financial institutions, to interface with a plurality of employees of the employers, to generate links for the employees to enroll in emergency savings plans of the employers, to retrieve enrollment information of the employees, to establish emergency savings accounts for the employees with one or more of the financial institutions, to transfer payroll deductions and employer-provided incentives from the employees' wages via the interfaces with the payroll systems to the established emergency savings accounts, and to retain employee information in the database.

In some embodiments, the secure savings-administration processor is further operable to link to financial-institution interfaces via application-programming-interface (API) calls, the ACH gateway, originating-depository-financial-institution (ODFI) protocols, private-key protocols, or the like. In some embodiments, the secure savings-administration processor is further operable to provide employers with a graphical user interface that is operable to implement a bonus plan as part of an employee's emergency savings account. In some embodiments, the secure savings-administration processor is further operable to group employees of an employer into different emergency savings plans. In some embodiments, the secure savings-administration processor is further operable to provide to the employers one or more graphical user interfaces that are operable to correct errors in the payroll deductions.

In an embodiment, a system includes a database and a secure savings-administration processor communicatively coupled to the database and operable to interface with a plurality of payroll systems of a plurality of employers, to interface with a plurality of financial-institution interfaces of a plurality of financial institutions, to maintain a subledger for each financial institution of a user's emergency savings, to interface with a plurality of employees of the employers, to generate links for the employees to enroll in emergency savings plans of the employers, to retrieve enrollment information of the employees, to establish emergency savings accounts (ESAs) for the employees with one or more of the financial institutions, to transfer payroll deductions from the employees' wages via the payroll interfaces to the established emergency savings accounts, to calculate employer matching amounts, and/or to retain employee information in the database.

In an embodiment, the secure savings-administration processor is further operable to link to the financial-institution interfaces via application-programming-interface calls, automated-clearinghouse (ACH) network protocols, originating-depository-financial-institution (ODFI) protocols, private-key protocols, or the like.

In an embodiment, the secure savings-administration processor is further operable to provide to the employers a graphical user interface that is operable to implement a bonus (e.g., award, reward, incentive, signup-bonus, milestone-bonus, employer-match) plan as part of an employee's emergency savings account.

In an embodiment, the secure savings-administration processor is further operable to group employees of an employer into different emergency savings plans. For example, the secure savings-administration processor can be operable to group employees into categories and to form or assign a respective emergency savings plan for each category.

In an embodiment, the secure savings-administration processor is further operable to provide to the employers one or more graphical user interfaces that are operable to correct errors in the payroll deductions.

One or more other illustrative embodiments (e.g., systems, system components (e.g., hardware or software), or computer-readable media relating to the foregoing embodiments) may be described below. The features, functions, and advantages that are discussed herein can be achieved independently in various embodiments or may be combined in yet other embodiments, further details of which can be understood with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a block diagram of an emergency savings account system, according to an embodiment.

FIGS. 2-12 illustrate various GUIs that can provide interactive functionality between a payroll interface of an employer and a secure savings-administration processor 20, according to an embodiment.

FIG. 13 depicts a cloud-computing system operable to execute programmed instructions embodied on a computer-readable medium, according to an embodiment.

### DESCRIPTION

The figures and the following description depict specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

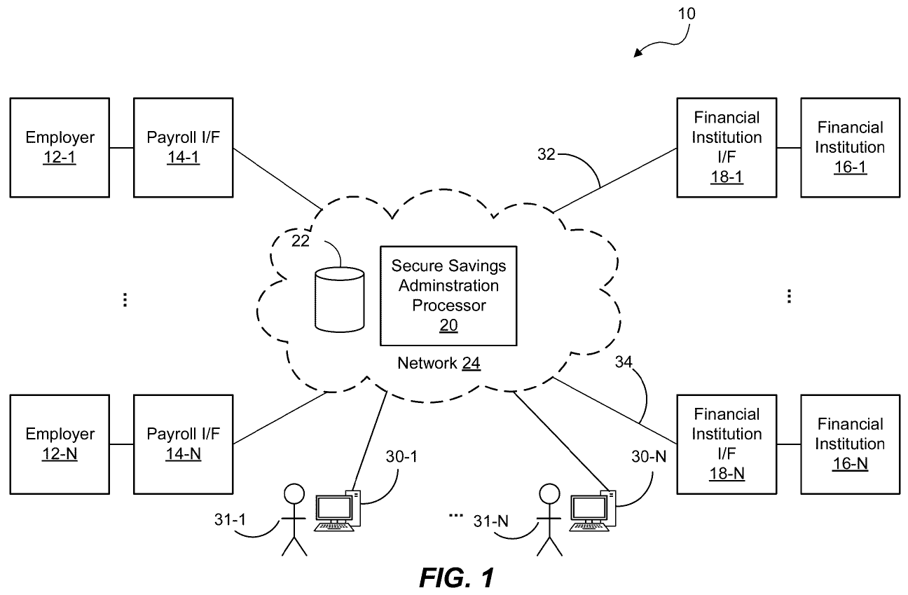

FIG. 1 is a block diagram of an emergency savings account (ESA) system 10, according to an embodiment. The ESA system 10 includes a secure savings-administration processor 20 and a database system 22 configured in a network 24 (e.g., a cloud computing network). The secure savings-administration processor 20 is linked to a plurality of payroll interfaces (I/F) 14-1-14-N of a plurality of employers 12-1-12-N (where the reference “N” is an integer greater than “1” and not necessarily equal to any other “N” reference designated herein). The secure savings-administration processor 20 is also linked to a plurality of financial institution interfaces (I/F) 18-1-18-N of a plurality of financial institutions 16-1-16-N. The secure savings-administration processor 20 can be called “secure” because it can implement appropriate security measures to prevent infiltration of the system 10, any of its components, the employers' systems, the financial-institutions' systems, the emergency savings accounts, or the personal computing devices, by bad actors.

The employers 12-1-N can interact with the secure savings-administration processor 20 to provide optional emergency savings plans for its employees 31-1-31-N. For example, employer 12-1 may hire the employee 31-1. Upon employment or after a predetermined waiting period commencing at the first day of employment, the employer 12-1 may issue a link to the secure savings-administration processor 20 as part of the employee's 31-1 digital hiring package. This link may be specific to the employee 31-1 though a custom encrypted token attached to the link, which may be sent to the employee via email, text message, or other direct-communication systems. The link to the secure savings-administration processor 20 allows the employee 31-1 to arrange for automatic deduction of a certain portion of each of the employee's 31-1 paychecks for placement in an ESA for use by the employee 31-1 during periods of personal emergency (e.g., healthcare, auto repair, or home repair). Assuming that the employee 31-1 enrolls in this plan, the secure savings-administration processor 20 interfaces with third-party services to validate the identity of the employee 31-1 and the accuracy of the information supplied by the employer 12-1, then interfaces with the payroll interface 14-1 of the employer 12-1 and begins deducting a portion of each of the employee's 31-1 paychecks, where the employee 31-1 has designated the portion for the emergency savings plan, and, if the employer 12-1 offers an ESA matching plan, then the secure savings-administration processor also can calculate, automatically, the appropriate employer-provided matching amount based on, e.g., the employee's 31-1 contribution, length of time enrolled in the program, total amount saved, existence or number of consecutive contributions, or other parameters, and can automatically transfer the matching amount from the employer to the employee's emergency savings account. Furthermore, each employee 31-1-31-N can interact with the secure savings-administration processor 20 via a respective personal computing device or system 30-1-30-N.

An employer 12 may have a preferred financial institution 16 that the employer uses for the employer's emergency savings plan. Alternatively, the financial institution 16 could be one that the secure savings-administration processor 20 has secured.

Once enrolled, the secure savings-administration processor 20 retains the personal information of the employee 31 in the database 22. Examples of such personal information may include, e.g., the employee's 31 name, birthdate, or login information, social security number, an employee ID, a home address, any number of linked banking-account numbers of one or more secondary financial institutions 16 and corresponding banking routing numbers of the one or more financial institutions, a payroll-deduction amount, the length of the employee's employment with the employer, or the like.

When the employee 31 is about to receive a paycheck during a payroll period, the payroll interface 14 of the employer 12 communicates with the secure savings-administration processor 20 to determine the payroll deduction for the employee 31 and the corresponding employer match (if any). The secure savings-administration processor 20 then can access the database system 22 to determine the payroll deduction for the employee 31 and to transfer that information to the payroll interface 14 of the employer 12 for making the payroll deduction. The payroll interface 14 then transfers the payroll deduction to the secure savings-administration processor 20, which, in turn, transfers the payroll deduction to the financial-institution interface 18 for deposit into the employee's 31 emergency savings account with the custodial financial institution 16. This process may continue for each paycheck or payroll period until the employee 31 opts out of the emergency savings plan and/or discontinues employment with the employer 12. However, the employee 31 retains his/her ESA, and the amount therein, until the employee 31 withdraws the funds in the ESA. That is, the ESA follows, e.g., is the property of, the employee 31, not the employer 12.

When the employee 31 is in need of emergency funds, the employee contacts the secure savings-administration processor 20 via the employee's 31 personal computing device 30 (e.g., a computer, a laptop, at tablet, a smart phone, or the like). For example, when the employee 31 enrolls in the emergency savings plan through a link provided by the employer 12 of the employee 31, the secure savings-administration processor 20 may provide a link to an application that the employee 31 may download on the employee's personal computing device 30. From inside of the “app,” the employee 31 can interact with the financial institution 16 to transfer funds from his/her account with the custodial bank to the employee 31, observe the employee's 31 account balance, alter the employee's 31 payroll deduction amount, manage emergency-savings-account info, etc.

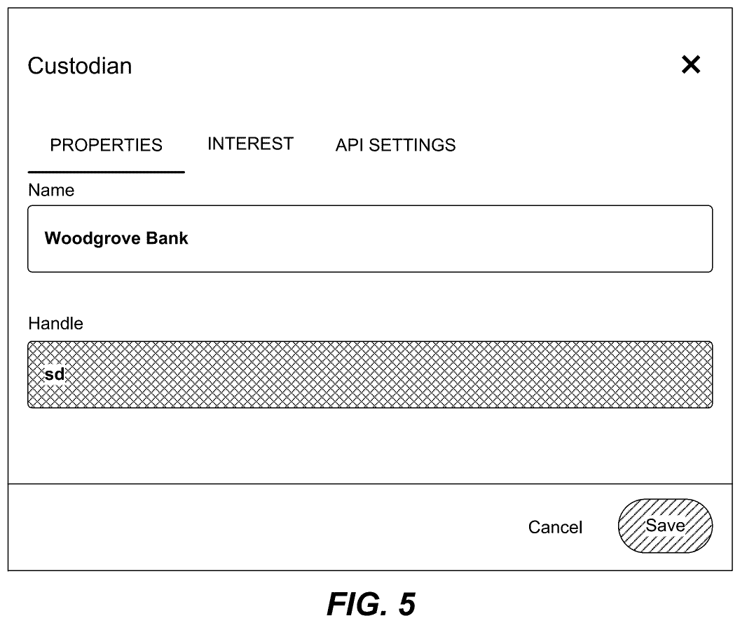

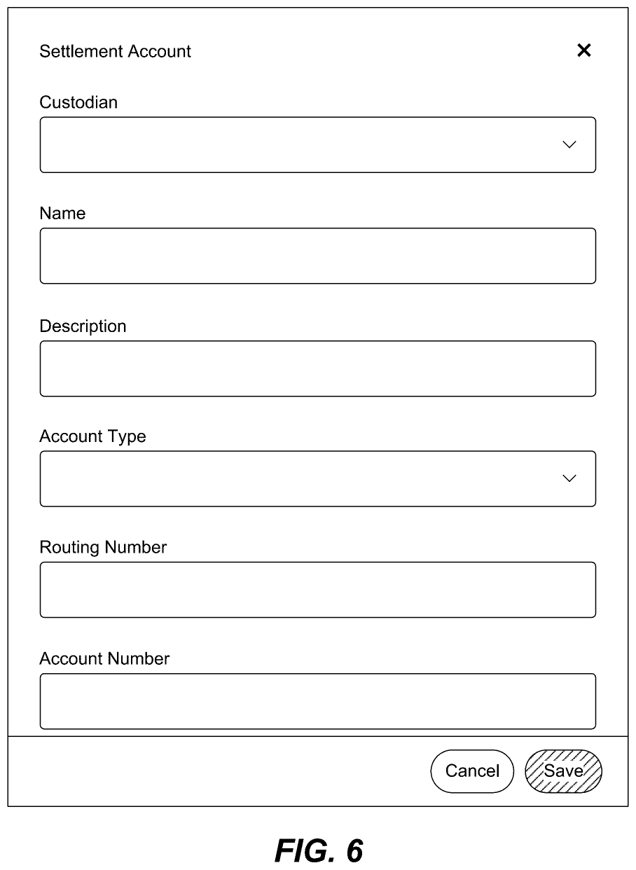

The secure savings-administration processor 20 also can be operable to communicate with the financial-institution interfaces 18 according to the various communication protocols of the financial-institution interfaces. For example, the financial-institution interface 18-1 may employ API (application-programming-interface) banking protocols in a link 32 (see, e.g., FIGS. 5 and 6). This interfacing ability can facilitate the secure savings-administration processor's 20 synchronization and connectivity to the financial institution's 16-1 tools and services. Once the link 32 is established, the financial institution 16-1 may allow the secure savings-administration processor 20 to access banking services of the financial institution 16-1, including making account transfers, making account-balance queries, and executing functions available from the financial institution 16-1. The link 32 also may allow the integration of the financial institution's 16-1 APIs with various products provided by the secure savings-administration processor 20. And, the link 32 may allow the secure savings-administration processor 20 to make API calls and fetches for the services of the financial institution 16-1 so that the secure savings-administration processor can execute, or can cause a computing system of the financial institution 16-1 to execute, banking operations, for examples banking operations related to the employee's 31-1 ESA.

The link 34, however, may employ originating-depository-financial-institution (ODFI) protocols used in connection with the national automated clearinghouse (ACH) network. Other examples of various protocols between a financial institution 16 and the secure savings-administration processor 20 that could be used include private-key operations, such as ACH processors or gateway operators, and the like. The secure savings-administration processor 20, therefore, can be operable to adapt to, and to implement, the communication and banking protocols of virtually any financial institution 16 such that the secure savings-administration processor can implement, on behalf of an employee 31, banking (e.g., banking related to an employee's ESA) between the employee's employer 12, or between the employee himself/herself, and any financial institution 16.

With the ability to interact with a plurality of financial institutions 16, the secure savings-administration processor 20 may pass through rates and services from the financial institutions 16. And, as the secure savings-administration processor 20 can be an administration entity, the accounts of the employees 31 managed by the secure savings-administration processor 20 still can be maintained and federally insured by the financial institutions 16.

In some embodiments, the secure savings-administration processor 20 is also operable to interact with the employer 12 (e.g., with the electronic payroll and other systems of the employer 12). For example, the secure savings-administration processor 20 may allow the employer 12 to configure certain options for the employee's 31 emergency savings plan.

Still referring to FIG. 1, alternate embodiments of the system 10 are contemplated. For example, the secure savings-administration processor 20 or the database 22 may be implemented on hardware, or in software, other than on or in a network such as the internet. For example, the secure savings-administration processor 20 may be implemented on a local or a remote server. Furthermore, one or more of the employers 12-1-12-N, financial institutions 16-1-16-N, employees 31-1-31-N, payroll interfaces 14-1-14-N, financial-institution interfaces 18-1-18-N, or personal computing devices 30-1-30-N may be separate from the system 10 or may be part of one or more other systems. Moreover, one or more of the payroll interfaces 14-1-14-N or financial-institution interfaces 18-1-18-N may form a respective part of, or be a respective component of, the secure savings-administration processor 20.

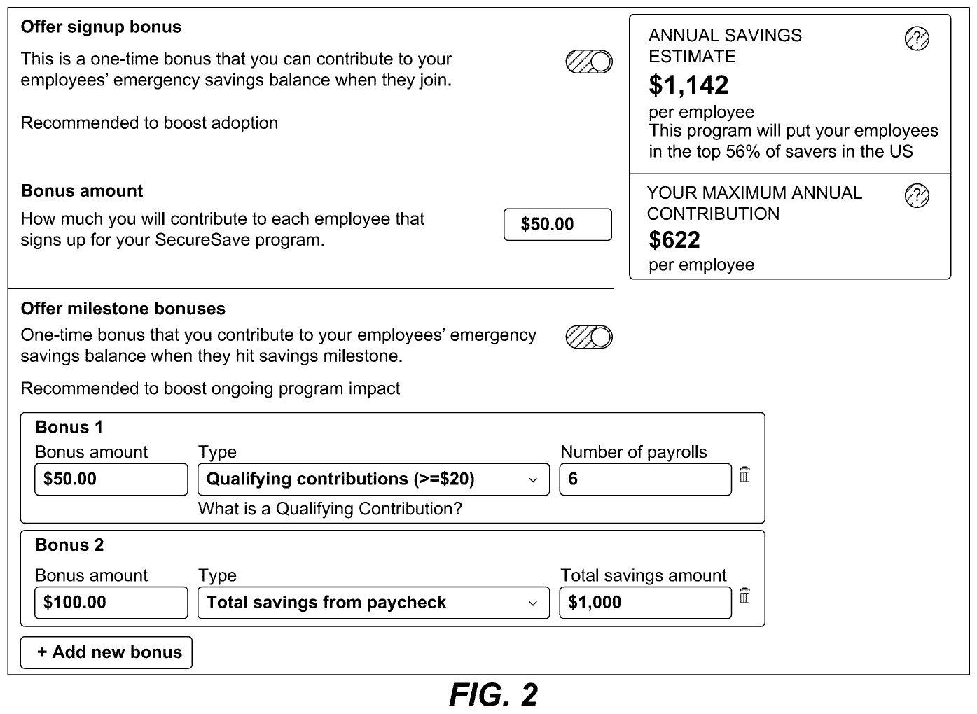

FIG. 2 illustrates a graphical user interface (GUI) through which the employer 12 can provide bonuses to its employees 31 to encourage its employees 31 to enroll in the emergency savings plan, according to an embodiment. Here, an employee 31 can be offered a one-time bonus of $50 for enrolling in the emergency savings plan. Alternatively or additionally, the secure savings-administration processor 20 can provide options such as milestone bonuses when an employee 31 reaches a particular savings amount in his/her emergency savings plan/account or saves for a certain amount of time or a certain number of payrolls. Another option may include recurring bonuses from an employer 12 to an employee 31 and the amount that the employer 12 wishes to grant to the employee 31 while the employee 31 is enrolled in the emergency savings plan and is contributing at a pre-defined level.

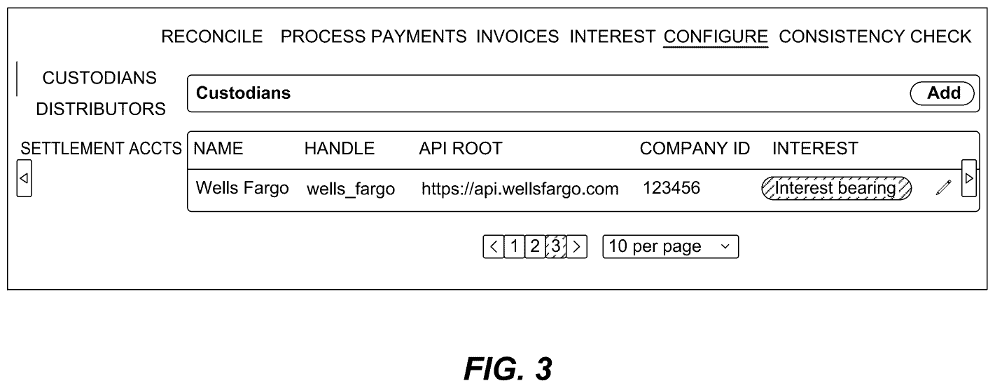

FIG. 3 is a diagram of another GUI that illustrates the account information of the financial institution 18 where the employee's 31 emergency savings account is located, according to an embodiment. The GUI also can reflect that the account is an interest-bearing account where the interest generated by the ESA deposits are returned to the employee's 31 ESA. The interest may be fixed, variable based on the balance in the ESA, or tiered such that an employee 31 with a larger balance may earn higher interest on the higher balance as compared to an employee 31 with a lower balance.

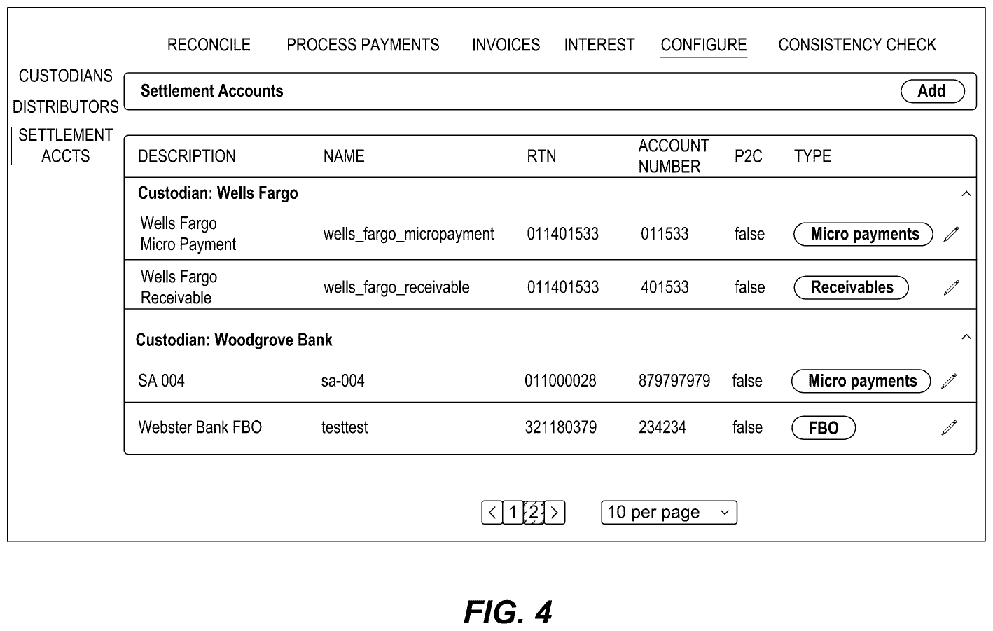

FIG. 4 illustrates another GUI with the account information and routing numbers of the employee's 31 ESA and the respective identity of one or more financial institutions 18, according to an embodiment.

FIG. 5 is a diagram of another GUI that allows an administrator, or another authorized party, to enter the name of the financial institution 18 holding the employee's 31 ESA, and to enter an online handle for the employee 31 or for another party, according to an embodiment. Alternatively, the GUI can be provided by the financial institution 18 holding the employee's 31 ESA with the name of the financial institution 16 already populated.

FIG. 6 is a diagram of another GUI that allows an administrator, or another party such as the financial institution 18 holding the employee's 31 ESA, to enter information related to the holding settlement for the ESA such as the custodian of the ESA if different, the name of the settlement account, the account type for the settlement account (such as a For-The-Benefit-Of (FBO) account), the routing number of the financial institution, or the settlement account number.

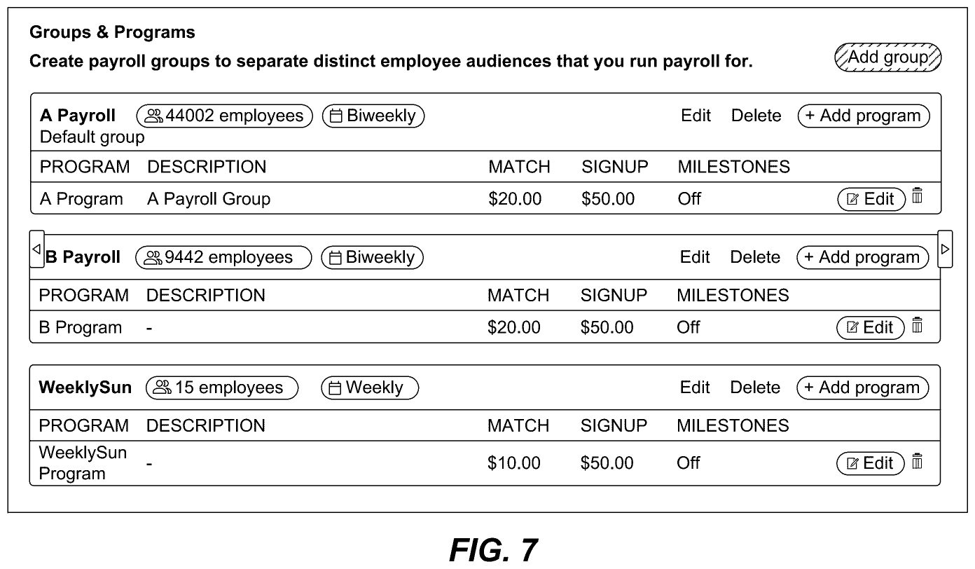

FIG. 7 is a diagram of another GUI that can be generated by the secure savings-administration processor 20 and illustrating how employees 31 may be categorized into various payroll groups for an employer 12, according to an embodiment. For example, a payroll group of employer 12 may have an initial sign-up bonus of $50 for an employee 31 entering into the emergency savings plan administered by the secure savings-administration processor 20 for the employer 12. That payroll group may include matching options, selectable by the employee 31, that the employer 12 wishes to contribute to the employee's 31 emergency savings plan. Various payroll groups may be configured to match certain payroll cycles at the employer, for different departments, for subdivisions or subsidiaries, or for groups of employees for whom the employer wishes to provide more customized emergency savings programs.

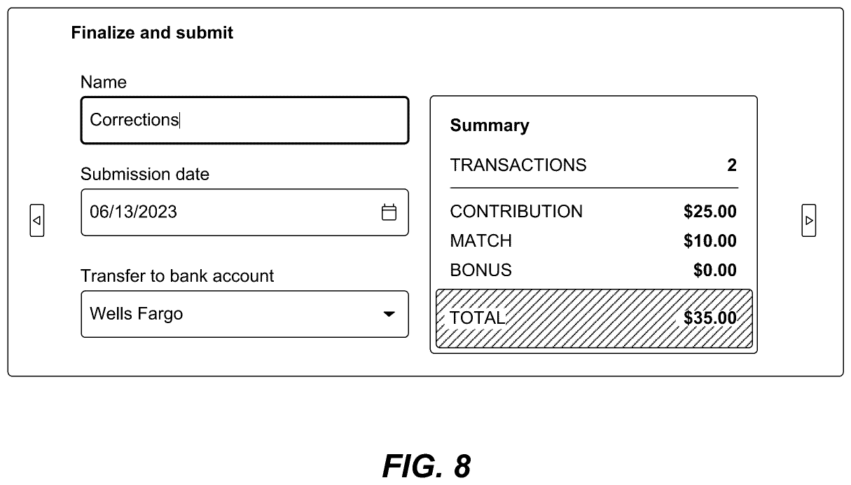

FIG. 8 is a diagram of another GUI that can be generated by the secure savings-administration processor 20 and that can allow an employer 12 to provide corrections and other related information to an employee's 31 emergency savings plan via the employer's 12 payroll interface 14, according to an embodiment. For example, if an error were to occur to an employee's 31 ESA deposit, the payroll interface 14 may issue, to the secure savings-administration processor 20, a correction to the employee's 31 ESA via the GUI.

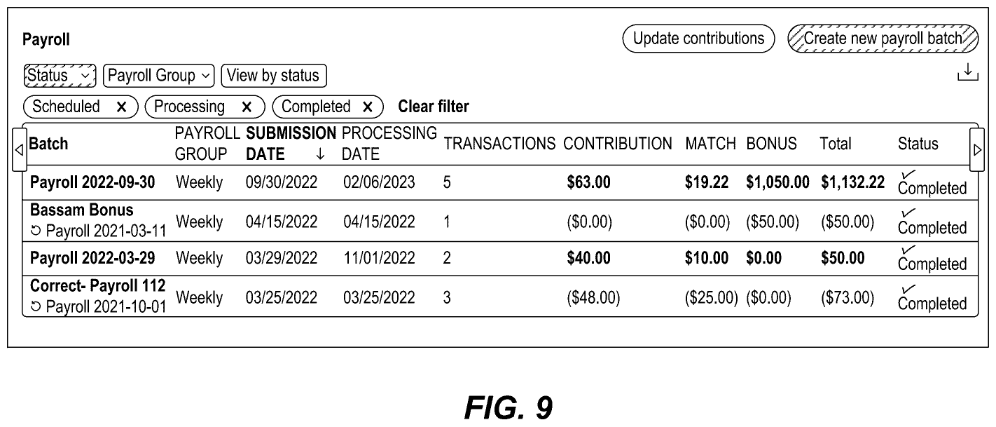

FIG. 9 is a diagram of another GUI that can be generated by the secure savings-administration processor 20 and that can provide a payroll interface 14 of an employer 12 with the ability to configure options to manage payroll batches of individual employees 31 and/or payroll groups in a manner related to the employees, payroll groups, or ESAs of the individual employees 31, according to an embodiment.

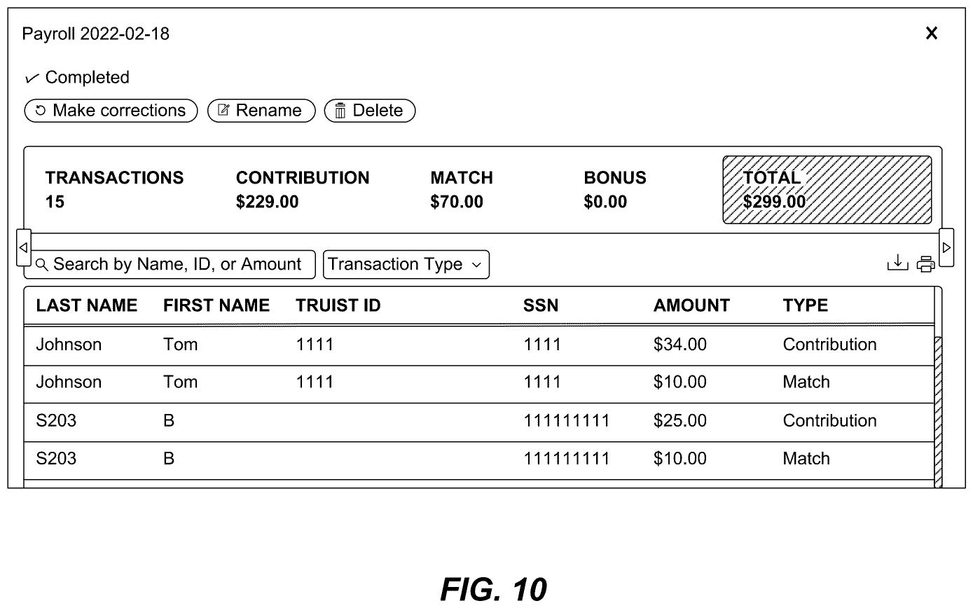

FIG. 10 is a diagram of another GUI that can be generated by the secure savings-administration processor 20 and that can provide the payroll interface 14 with the ability to make corrections to payrolls, payroll withdrawals/employee contributions, or employer matches, according to an embodiment.

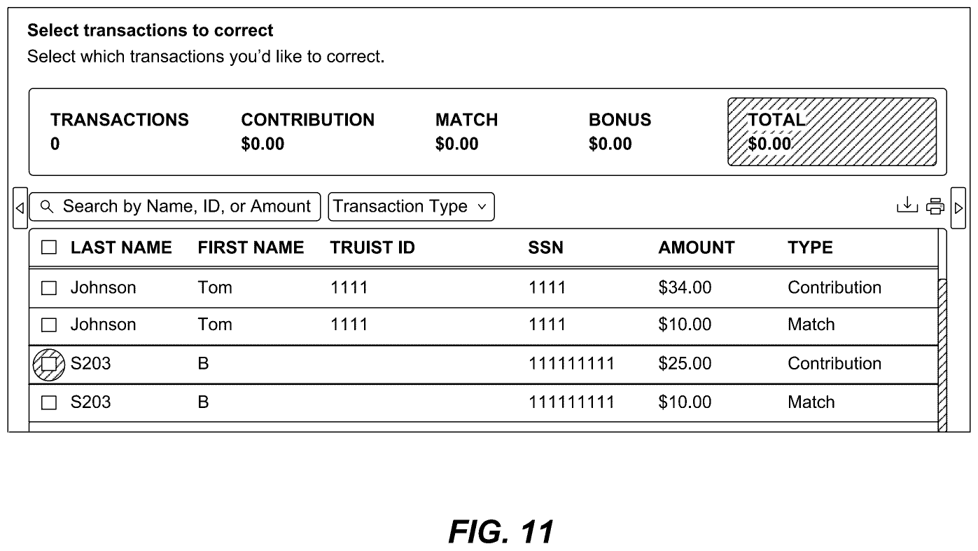

FIG. 11 is a diagram of another GUI that can be generated by the secure savings-administration processor 20 and that can allow the payroll interface 14 to select individual transactions (e.g., one or more transactions related to an employee's 31 ESA) for corrections, according to an embodiment.

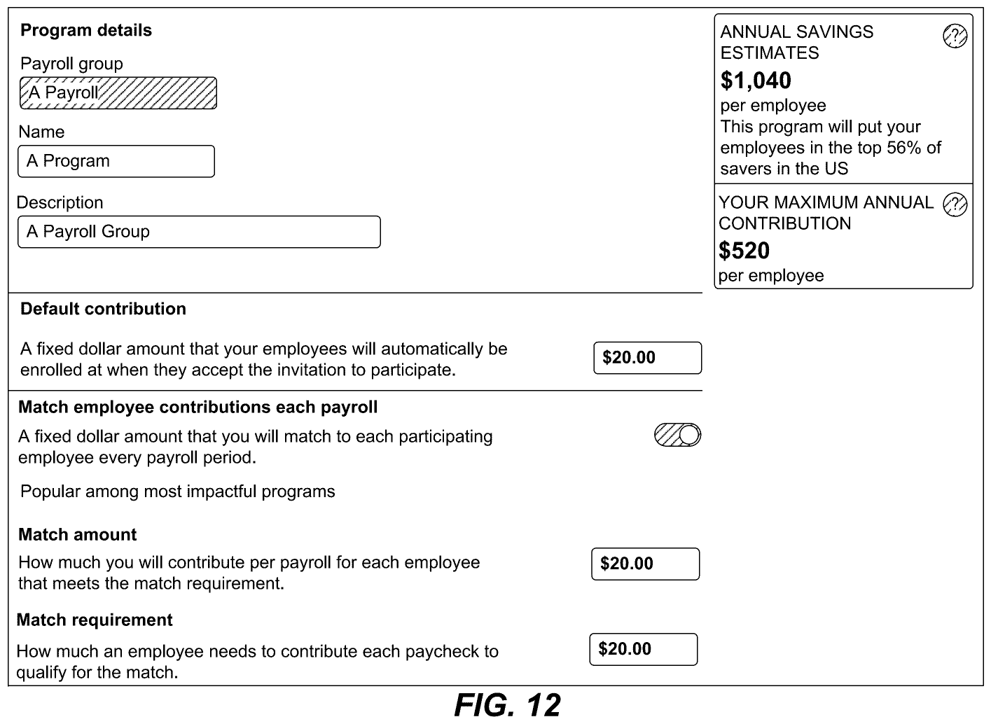

FIG. 12 is a diagram of yet another GUI that can be generated by the secure savings-administration processor 20 and that can allow the secure savings-administration process to provide individual details to the payroll interface 14 of an employer 12 regarding a particular payroll group of the employer, according to an embodiment. That is, such a GUI can allow the payroll interface 14 to configure, or can facilitate the payroll interface in configuring, default contributions to an employee's 31 ESA and matching amounts while also providing information pertaining to the particular payroll group (e.g., estimated annual savings, maximum contributions) to which the employee belongs, e.g., for purposes of the employer's emergency savings plan.

Any of the various computing and/or control elements shown in the figures or described herein may be implemented as hardware, as a processor implementing software or firmware, or some combination of these. For example, an element may be implemented as dedicated hardware. Dedicated hardware elements may be referred to as “processors,” “controllers,” “microprocessors,” “microcontrollers,” or some similar terminology. When provided by a processor, the functions may be provided by a single dedicated processor, by a single shared processor, or by a plurality of individual processors, some of which may be shared. Moreover, explicit use of the terms “processor,” “controller,” or the like should not be construed to refer exclusively to hardware capable of executing software, and may implicitly include, without limitation, digital signal processor (DSP) hardware, a network processor, an application specific integrated circuit (ASIC) or other circuitry, a field-programmable gate array (FPGA), read-only memory (ROM) for storing software, random-access memory (RAM), non-volatile storage, logic, or some other physical hardware component or module.

In an embodiment, instructions stored on a computer-readable medium can direct a computing system of any of the devices and/or servers discussed herein to perform the various operations disclosed herein. In some embodiments, all or portions of these operations may be implemented in a networked computing environment, such as in a cloud computing system. Cloud computing often includes on-demand availability of computer-system resources, such as data storage (cloud storage) and computing power, without direct active management by a user. Cloud computing can rely on the sharing of resources, and generally can include on-demand self-service, broad network access, resource pooling, rapid elasticity, and measured service.

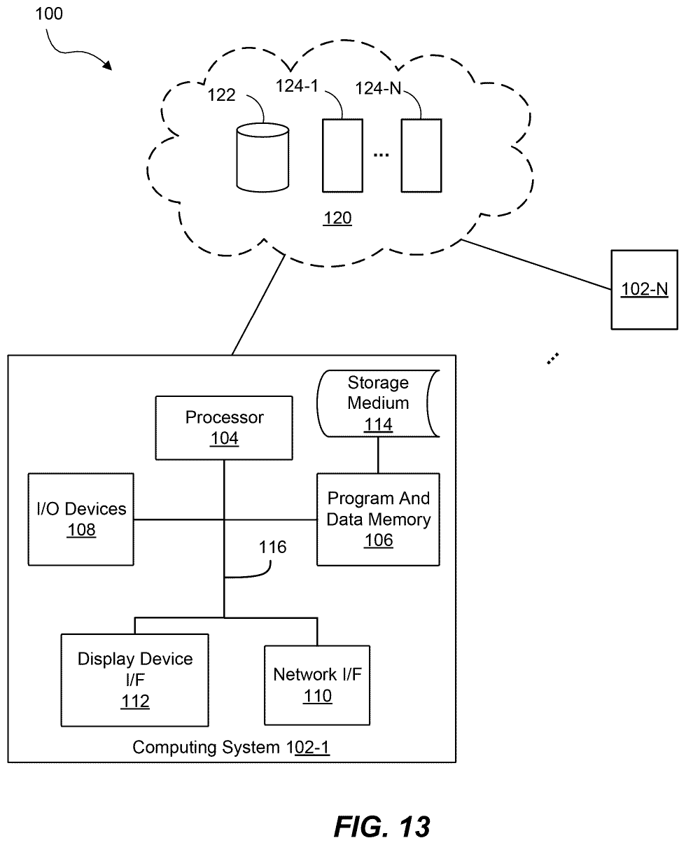

FIG. 13 is a diagram of a cloud computing system 100, which can be operable to perform the above-described operations by executing programmed instructions tangibly embodied on one or more non-transitory computer-readable storage mediums, according to an embodiment. The cloud computing system 100 generally includes the use of a network of remote servers hosted on the internet to store, manage, and process data, rather than a local server or a personal computer (e.g., in the computing systems 102-1-102-N). Cloud computing can enable users, such as employers, employees, or financial institutions, to use infrastructure and applications via the internet, without installing and maintaining them on-premises. In this regard, the cloud computing network 120 may include virtualized information technology (IT) infrastructure (e.g., servers 124-1-124-N, a data-storage module 122, operating-system software, networking, and other infrastructure) that is abstracted so that the infrastructure can be pooled and/or divided irrespective of physical-hardware boundaries. In some embodiments, the cloud computing network 120 can provide users with services in the form of building blocks that can be used to create and deploy various types of applications in the cloud on a metered basis.

Various components of the cloud computing system 100 may be operable to implement one or more operations, such as the heretofore-described operations, in their entireties or to contribute to one or more of the operations in part. For example, a computing system 102-1 may be used to perform operations (e.g., operations related to one or more ESAs) of the secure savings-administration processor 20 and to retain (e.g., store) data pertaining to those operations in the data-storage module 122 (e.g., a database) of a cloud computing network 120. Various computer servers 124-1-124-N of the cloud computing network 120 may be used to operate on the data, and/or to transfer the data to another computing system 102-N (e.g., another cloud computing system or another type (e.g., a local-server-based) of computing system).

Some embodiments disclosed herein may utilize instructions (e.g., code/software) accessible via a tangible, non-transitory computer-readable storage medium for use by various components in the cloud computing system 100 to implement all or parts of the various operations disclosed herein. Examples of such components include the computing systems 102-1-102-N.

Components of the computing systems 102-1-102-N, according to an embodiment, may include at least one processor 104, a computer-readable storage medium 114 (e.g., a hardware memory such as a computer memory or thumb drive, see below), program and data memory 106, at least one input/output (I/O) device 108, a display device interface 112, and a network interface 110. For the purposes of this description, the computer-readable storage medium 114 can comprise any tangible non-transitory physical media that is capable of storing a program for use by the computing system 102. For example, the computer-readable storage medium 114 may be an electronic, magnetic, optical, electromagnetic, infrared, semiconductor device, or other tangible non-transitory medium. Examples of the computer-readable storage medium 114 include a solid-state memory, a magnetic tape, a removable computer diskette, a random-access memory (RAM), a read-only memory (ROM), a rigid magnetic disk, or an optical disk. Some examples of optical disks include Compact Disk-Read Only Memory (CD-ROM), Compact Disk-Read/Write (CD-R/W), Digital Versatile Disc (DVD), and Blu-Ray Disc.

The processor 104 is coupled to the program and data memory 106 through a system bus 116. The program and data memory 106 includes local memory employed during actual execution of the program code, bulk storage, and/or cache memories that provide temporary storage of at least some program code and/or data in order to reduce the number of times the code and/or data are retrieved from bulk storage (e.g., a hard-disk drive, a solid-state drive, or the like) during execution.

Input/output or I/O devices 108 (e.g., including, but not limited to, keyboards, displays, touchscreens, microphones, or pointing devices) may be coupled to the bus 116 and/or the processor 104 either directly or through one or more intervening I/O controllers (not shown in FIG. 13). One or more network-adapter interfaces 110 also may be integrated with the computing system 102-1 to enable the computing system to become coupled to other computing systems or storage devices through intervening private or public networks. The network-adapter interfaces 110 may be implemented as modems, cable modems, Small Computer System Interface (SCSI) devices, Fibre Channel devices, Ethernet cards, wireless adapters, etc. Display device interface 112 may be integrated with the system to interface to one or more display devices, such as screens for presentation of data generated by the processor 104.

Although the foregoing text sets forth a detailed description of numerous different embodiments, it should be understood that the scope of protection is defined by the words of the claims to follow. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A system, comprising:
a secure savings-administration processor configured to:
establish, at a financial institution, an emergency savings account for an employee of an employer; and
direct, to the emergency savings account, a payroll deduction taken by the employer from wages of the employee.

2. The system of claim 1 wherein the secure savings-administration processor is configured to transfer, from the employer to the emergency savings account, a reward in response to the secure savings-administration processor establishing the emergency savings account.

3. The system of claim 1 wherein the secure savings-administration processor is configured to direct, from the employer to the emergency savings account, a matching contribution related to an amount of the payroll deduction and in response to directing the payroll deduction to the emergency savings account.

4. The system of claim 1 wherein the secure savings-administration processor is configured to transfer, from the employer to the employee, an award in response to the secure savings-administration processor establishing the emergency savings account.

5. The system of claim 1 wherein the secure savings-administration processor is configured to:
receive, from the employee, a request to establish an emergency savings account; and
establish the emergency savings account in response to the request.

6. The system of claim 1 wherein the secure savings-administration processor is configured to communicate with each of the employer, employee, or financial institution via a respective application programming interface.

7. The system of claim 1, further comprising:
a respective application programming interface for each of at least one of the employer, the employee, or the financial institution; and
wherein the secure savings-administration processor is configured to communicate with each of at least one of the employer, employee, or financial institution via the respective application programming interface.

8. The system of claim 1, further comprising:
a database; and
wherein the secure savings-administration processor is configured to
receive, from the employer, information related to the employee, employer, or financial institution; and
store the information in the database.

9. The system of claim 1, further comprising:
a database; and
wherein the secure savings-administration processor is configured to
receive, from the employee, information related to the employee, the employer, or the financial institution; and
store the information in the database.

10. The system of claim 1, further comprising:
a database; and
wherein the secure savings-administration processor is configured to
receive, from the financial institution, information related to the employee, employer, or financial institution; and
store the information in the database.

11. The system of claim 1 wherein the secure savings-administration processor is configured to transfer funds from the emergency savings account to the employee.

12. A method, comprising:
establishing, at a financial institution with a secure savings-administration processor, an emergency savings account for an employee of an employer; and
directing, to the emergency savings account, a payroll deduction taken by the employer from wages of the employee.

13. The method of claim 12, further comprising transferring, from the employer to the emergency savings account with the secure savings-administration processor, a reward in response to the secure savings-administration processor establishing the emergency savings account.

14. The method of claim 12, further comprising directing, from the employer to the emergency savings account with the secure savings-administration processor and along with the payroll deduction, a matching contribution related to an amount of the payroll deduction.

15. The method of claim 12, further comprising directing, from the employer to the employee, an award in response to the secure savings-administration processor establishing the emergency savings account.

16. The method of claim 12, further comprising:
receiving, from the employee at the secure savings-administration processor, a request to establish an emergency savings account; and
wherein the establishing includes establishing, with the secure savings-administration processor, the emergency savings account in response to the request.

17. The method of claim 12, further comprising communicating, using the secure savings-administration processor, with each of the employer, employee, or financial institution via a respective application programming interface.

18. The method of claim 12, further comprising:
receiving, from the employer with the secure savings-administration processor, information related to the employee, employer, or financial institution; and
storing, with the secure savings-administration processor, the information in a database.

19. The method of claim 12, further comprising:
receiving, from the employee with the secure savings-administration processor, information related to the employee, employer, or financial institution; and
storing, with the secure savings-administration processor, the information in a database.

20. The method of claim 12, further comprising:
receiving, from the financial institution with the secure savings-administration processor, information related to the employee, employer, or financial institution; and
storing, with the secure savings-administration processor, the information in a database.

21. The method of claim 12, further comprising:
receiving, from the employee with the secure savings-administration processor, a request for an amount from the emergency savings account;
withdrawing the amount from the emergency savings account with the secure savings-administration processor in response to the request; and
transferring the amount to the employee with the secure savings-administration processor in response to the withdrawing.

22. The method of claim 12, further comprising:
receiving, from the employer with the secure savings-administration processor, information regarding an emergency-savings-account-related group to which the employee belongs.

23. A tangible non-transitory computer-readable medium storing instructions that, when executed by a secure savings-administration processor, cause the secure savings-administration processor, or other circuitry under the control of the secure savings-administration processor, to:
establish, at a financial institution, an emergency savings account for an employee of an employer; and
transfer, to the emergency savings account, payroll deductions automatically taken by the employer from periodic wages that the employer pays to the employee.
